(19) United States
(12) Patent Application Publication
(10) Pub. No.: US 2009/0015907 A1
(43) Pub. Date: Jan. 15, 2009

(54) Nanocrystal indium oxynitride thin film optical filter

(75) Inventors: Jiti Nukeaw, Bangkok (TH); Supanit Porntheeraphat, Pathumthani (TH); Apichart Sungthong, Bangkok (TH)

Correspondence Address: REED SMITH LLP, Suite 1400, 3110 Fairview Park Drive, Falls Church, VA, 22042, US

(73) Assignee: National Science Technology Development Agency

(21) Appl. No.: 11/826,162

(22) Filed: Jul. 12, 2007

(51) Int. Cl. F21V 9/04

(52) U.S. Cl. 359/359; 359/589; 204/192.15; 977/724; 977/902; 359/586

(57) ABSTRACT

Nanocrystal indium oxynitride (InON) thin films are used as a functional layer for optical high-pass filters or devices. The filters or devices function in ultraviolet to near infrared regions by the sputtering conditions. The thin film is deposited with radio frequency (RF) magnetron sputtering. The 99.999% purity of metal Indium (In) was used as a target in the sputtering process. The two mass flow controllers were use to control the flow rate of ultra high purity nitrogen and oxygen (as the reactive gases) to sputter the target onto the substrates without heating. The InON thin film was deposited on glass or plastic substrates so prepared can provide optical filters without any post-process requirement.

### BACKGROUND OF THE INVENTION

1. Field of the Invention

The present invention relates to an apparatus and a method for growing nanocrystalline thin films. More particularly, nanocrystal indium oxynitride (InON) thin film suitably uses for high-pass optical filters.

2. Description of the Related Arts

Indium Nitride (InN) has become the focus of growing interest as a III-V nitride semiconductor such as gallium nitride (GaN) and aluminum nitride (AlN). InN has the lowest direct band gap among III-V nitride compound. Generally, InN thin film has the hexagonal structure. InN semiconductor can be fabricated with other III-V compounds to-form the advance devices operating in the red, green and blue light regions. It possesses potential applications in optoelectronic devices such as light-emitting diodes (LEDs), laser diodes (LDs), full color displays, and high efficiency and low cost solar cells. As a result, InN is one of the key technologies for further developing III-V nitride semiconductor devices. Since InN can be fabricated below 100° C., the reactive rf sputtering is used to prepare high quality polycrystalline films. By this method, the nanocrystal indium oxynitride thin films were grown with a reactive gas control technique. The optical properties of indium oxynitride thin films depended on the nitrogen and oxygen flow rates fed into the sputtering chamber. The novel functional films were applied to optical filters.

### SUMMARY OF THE INVENTION

Indium oxynitride (InON) thin films were grown by RF magnetron sputtering. The 99.999% purity of Indium was used as the target in the sputtering process. The two mass flow controllers were use to control the flow rates of ultra high purity nitrogen and oxygen as the reactive mixed-gases. The nano-polycrystalline structure of films was achieved by this technique. The optical properties of the films depended on the nitrogen and oxygen flow rates into the sputtering chamber. The InON films were used as a functional layer for optical high-pass filters. The devices function in ultraviolet to near infrared regions by the proper sputtering conditions. The films were prepared on glass or plastic substrates by this technique working as optical filters without any post-process requirements.

### BRIEF DESCRIPTION OF THE FIGURES

The foregoing features and advantages of the invention will become apparent from the following more particular description of preferred embodiments of the invention, as illustrated in the accompanying drawings, in which:

FIG. 1: The X-ray diffraction (XRD) patterns of indium oxynitride thin films, which were deposited on substrates using the reactive mixed-gas of nitrogen and oxygen flow rates controlled in difference conditions.

FIG. 2: The field emission scanning electron microscope (FE-SEM) images of indium oxynitride thin films, which were deposited on substrates using nitrogen and oxygen flow rates controlled in difference conditions. The magnification is 100K times for all images.

FIG. 3: The transmission spectra of indium oxynitride thin films, which were deposited on substrates using nitrogen and oxygen flow rates controlled in difference conditions.

FIG. 4: The optical filters pictures, which indium oxynitride thin films were deposited on substrates using nitrogen and oxygen flow rates controlled in difference conditions. The film colors were differentiated from clear to dark-red-brown.

### DETAILED DESCRIPTION OF THE INVENTION

The nanocrystal indium oxynitride thin film optical filter of the present invention is an optical filter which can controllable in a transmission spectra range. The filters suitably use for ultraviolet (UV) to near infrared (IR) regions. The films were deposited on substrates by nitrogen/oxygen mixed gas using RF magnetron sputtering. The colors of films were differentiated from clear to dark-red-brown, which the difference colors and optical properties were depended on the gases flow rate control. The novel flexible optical filter was achieved, using plastic as a substrate of the device.

The objective of the invention is to provide the optical filter using a new functional material. The novel functional material is indium oxynitride. The filter acts as a high pass optical filter. The optical filter fabrication was simple and cost effective. As the results, this novel optical filter is cheaper than other optical filters in the market.

### Completely Method of the Invention

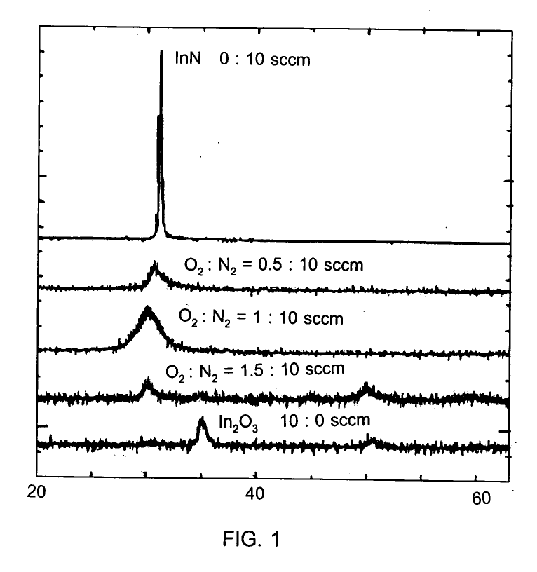

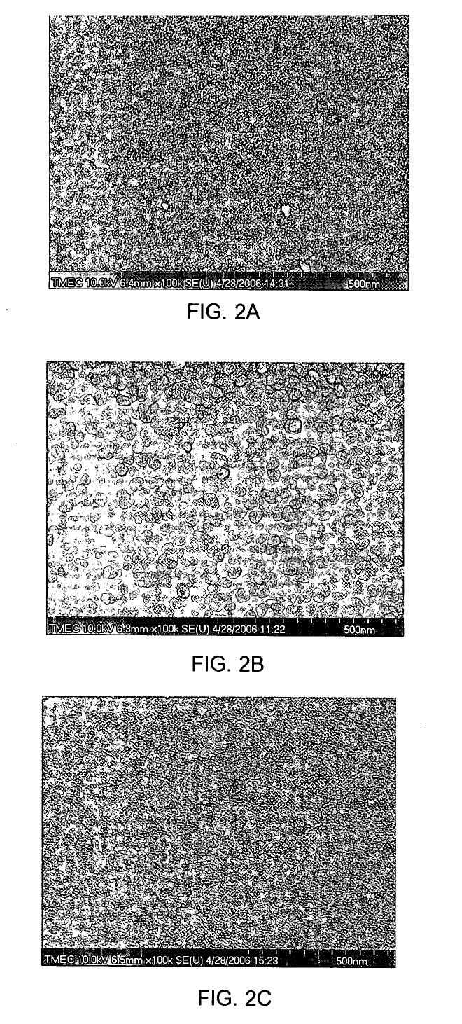

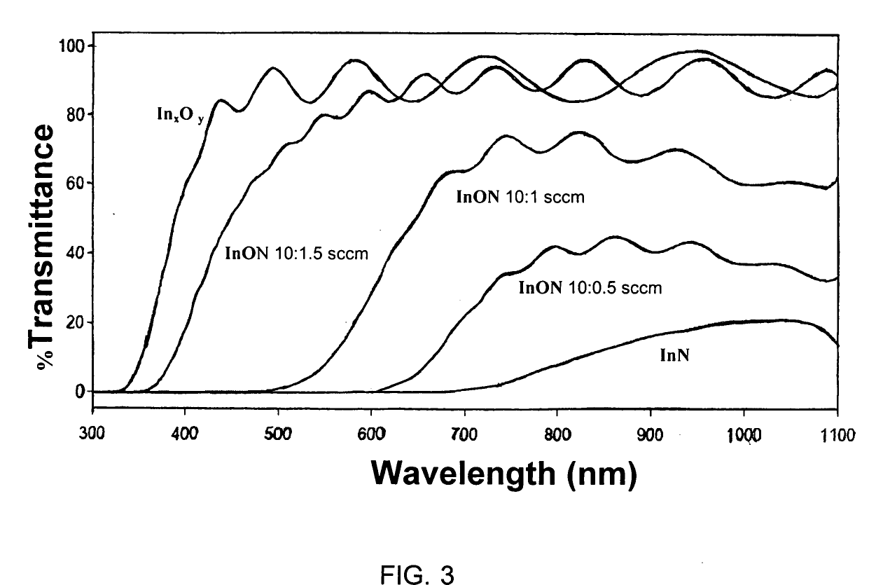

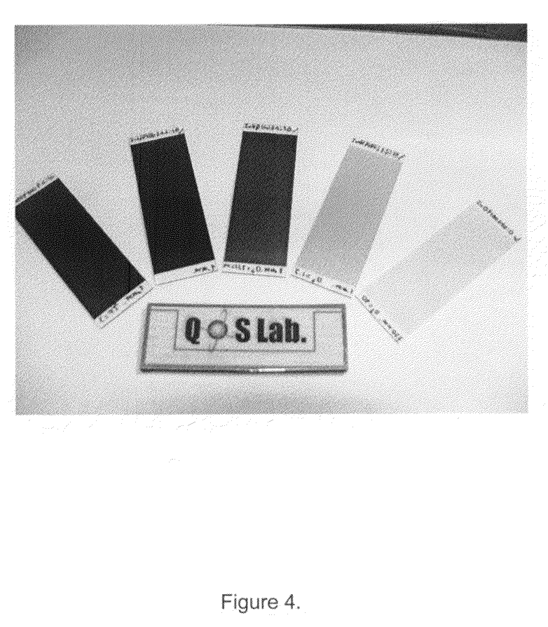

Indium oxynitride (InON) thin films were grown on substrates by RF magnetron sputtering without substrate heating. The 99.999% purity of Indium was used as the target in the sputtering process. The distance between indium target and substrate was ˜5 cm. The two mass flow controllers are used to control the flow rates of ultra high purity nitrogen and oxygen fed into the sputtering chamber. The nitrogen-oxygen mixed was fed into the chamber for reactive gas plasma generated from RF. The plasma was significantly processed for sputter indium target, hence the indium atom were deposited onto substrate. The substrate cleaning was done by a special process. After that, the substrate was set on the substrate holder in the chamber, and then the chamber was evacuated until ˜10⁻⁷ mbar. The sputtering process began with feeding of 99.999% purity nitrogen flow rate at 10 sccm (Standard Cubic Centimeter per Minute) and 99.999% purity oxygen flow rate at 0, 0.5, 1, 1.5 and 10 sccm, respectively as different conditions. The RF generator (13.56 MHz) generated a radio frequency of 100 watt power. The radio frequency excited the nitrogen-oxygen mixed gas to produce the plasma state, and then the sputtering process begun. The thicknesses of films were verified by a quartz balance thickness monitor. The structural and optical properties of thin films were characterized by a X-ray Diffraction (XRD) spectrometer, a Field Emission Scanning Electron Microscopy (FE-SEM) and a UV-VIS spectrophotometer, respectively. The XRD patterns of indium oxynitride thin films shown in FIG. 1 (2-theta of angles range from 20 to 65 are on x axis, and counts of wavelength intensity are on y axis), which were deposited on substrates using oxygen-nitrogen (O₂:N₂) flow rate control in difference conditions. The InN (0:10 sccm), InNO (0.5:10, 1.0:10 and 1.5:10 sccm) and The InO (10:0 sccm) crystal structures were demonstrated hexagonal, cubic and body-center rhombohedral polycrystalline structures, respectively. FE-SEM images of InON thin films as shown in FIG. 2, which were deposited on substrates using O₂:N₂ flow rate control in difference conditions. All of thin films have crystal size in nanometer scale. The microstructures of InN and InO are provided in less than 10 nm in FIGS. 2A and 2C. The microstructure of InON is provided in about 50 nm in FIG. 2B. The transmission spectra of InₓO_{y}, InON, InN thin films in the wavelength range of 300-1100 nm are shown in FIG. 3, which deposited substrates using O₂:N₂ flow rate control in difference conditions. As the results, the optical properties depended on the O₂:N₂ flow rate control, significantly. The optical filters as shown in FIG. 4, InₓO_{y}, InON, InN thin films were deposited on substrates using O₂:N₂ flow rate control in difference conditions. The colors of films were differentiated from clear to dark-red-brown (corresponding to In—O—N compounds in thin film growth conditions). The films were used as a functional layer for optical high-pass filter. The devices perform in ultraviolet to near infrared regions by the proper sputtering conditions.

### Experimental

As the completely method of the invention, the significantly technique is the nitrogen and oxygen flow rate control. The InON thin films were suitably use for optical filters and its functional wavelength regions.

The principles, preferred embodiments and modes of operation of the present invention have been described in the foregoing specification.

However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for producing an indium oxynitride thin film optical filter including one of:
nanocrystal indium nitride thin films deposited on a glass or plastic substrates;
nanocrystal indium oxynitride thin films deposited on the glass or plastic substrates; and
nanocrystal indium oxide thin films deposited on the glass or plastic substrates, the method comprising:
providing the glass or plastic substrates in a RF magnetron sputtering system;
controlling O₂:N₂ flowing into the RF magnetron sputtering system at fixed rates, and
using indium as a sputtering target onto the glass or plastic which is not heated during a sputtering process thereby depositing the thin films on the glass or plastic substrates.

2. The method of claim 1, wherein the controlling step involves fixing the flow rate of nitrogen at 10 sccm and the flow rate of oxygen at 0.5, 1, or 1.5 sccm to deposit the indium oxynitride thin films.

3. The method of claim 1, wherein the controlling step involves fixing the flow rate of nitrogen at 10 sccm and the flow rate of oxygen at 0 to deposit the indium nitride thin films.

4. The method of claim 1, wherein the controlling step involves fixing the flow rate of nitrogen at 0 sccm and the flow rate of oxygen at 10 to deposit the indium oxide thin films.

5. A indium oxynitride thin film optical filter comprising one of:
nanocrystal indium nitride thin films deposited on a glass or plastic substrates;
nanocrystal indium oxynitride thin films deposited on the glass or plastic substrates; and
nanocrystal indium oxide thin films deposited on the glass or plastic substrates,
wherein the thin films have crystal sizes in nanometer scale.

6. The indium oxynitride thin film optical filter of claim 5, the plastic substrate used for flexible optical filters.

7. The indium oxynitride thin film optical filter of claim 5, the films are used as a functional layer for optical high-pass filter in ultraviolet to near infrared regions.

8. The indium oxynitride thin film optical filter of claim 5, wherein the indium nitride thin films, the indium oxynitride thin films, and indium oxide thin films demonstrate hexagonal, cubic and body-center rhombohedral polycrystalline structures, respectively.
